(19) United States
(12) Patent Application Publication
(10) Pub. No.: US 2018/0368310 A1
(43) Pub. Date: Dec. 27, 2018

(54) Multi-Line Manure Applicator

(71) Applicant: Raymond Zimmerman, Cantril, IA (US)

(72) Inventor: Raymond Zimmerman, Cantril, IA (US)

(21) Appl. No.: 15/634,987

(22) Filed: Jun. 27, 2017

(51) Int. Cl. A01C 23/00; B05B 1/20; B05B 1/30; A01C 23/04

(52) U.S. Cl. CPC A01C 23/002; B05B 1/20; A01C 23/04; A01C 23/008; B05B 1/30

(57) ABSTRACT

A manure applicator may include a tool bar, a plurality of spaced apart application points along the tool bar, a distribution manifold operatively connected to the tool bar and configured to receive a supply of manure under pressure pumped from a manure reservoir, a plurality of discharge lines, each of the plurality of discharge lines between the distribution manifold and one of the plurality of spaced apart application points, a plurality of independent and separate flow meters, with each of the flow meters along one of the plurality of discharge lines, and a plurality of independent and separate flow valves, with each of the flow valves along one of the plurality of discharge lines.

### FIELD OF THE INVENTION

The present invention relates to manure applicators. More particularly, the present invention relates to multi-line manure applicators where flow in each line is separately and independently measured and separately and independently controlled.

### BACKGROUND OF THE ART

It is well known to apply animal manure to agricultural fields as fertilizer. Such a practice is advantageous as it allows animal waste products from feedlots or confinement facilities to be used to enrich soil with nutrients. This may reduce fertilizer costs while reducing risk of pollution to ground or surface water. In modern practice, there are two main types of manure applications, tank based and drag hose. In tank based systems, manure is held within a tank of an agricultural implement and a pump is used to apply sufficient pressure to allow the manure to be distributed through a host system to each row. In the drag hose system, the manure may be in a reservoir and a hose has one end placed within the reservoir and the other end is on the implement. A pump system is used to pump the manure through the hose to the implement where it is distributed to a plurality of different nozzles or outlets spaced apart on a tool bar.

An implement for applying manure will typically have multiple rows and the greater the number of rows the larger the area of the field which can be covered in a single pass saving time and fuel costs. High pressures are used to apply the manure. It should be understood that manure is not of uniform consistency and includes solid materials including roughage or other materials ingested by the animals, bedding, or otherwise and so application of manure is fundamentally different than application of anhydrous ammonia or other fertilizers, chemicals, seed, or other agricultural inputs.

Another issue is that state and federal regulations may require management of phosphorus which can affect the application rate for manure. Thus, a producer who has an approved manure management plan the producer is responsible for maintaining compliance with that plan through management of application rates for the manure being applied.

One of the problems with conventional practices is that manure is spread unevenly. This can result in yellow streaking in fields indicative of uneven application and raising concerns about nitrogen availability which may adversely impact yields. Uneven application can occur if a hose line or application point is blocked with solid materials within the manure for a time. Uneven application can occur if the field includes hills or slopes. Thus, where a boom has one end elevated above the other end due to uneven terrain, less manure is distributed at the high end than the low end. This problem is increased the wider the area the manure applicator covers. Therefore, problems remain. What is needed is an improved manure applicator which provides for even application of manure.

Uniform liquid manure distribution across the application tool-bar is important for proper use of nutrients. Uniform distribution of manure across the tool-bar swath ensures minimal variability among application points. Uneven manure application, especially under low application rates, can potentially lead to uneven response in crop growth.

### SUMMARY

Therefore, it is a primary object, feature, or advantage of the present invention to improve over the state of the art.

It is a further object, feature, or advantage to provide an improved manure application which provides for even application of manure.

It is a still further object, feature, or advantage to provide an improved manure applicator which provides for independently and separately measuring flow at each of a plurality of lines.

Another object, feature, or advantage is to separately and independently control flow rate at each of a plurality of lines.

Yet another object, feature, or advantage is to maintain high pressure levels so as to apply liquid manure which may include some solid materials.

One or more of these and/or other objects, features, or advantages will become apparent from the specification and claims that follow. No single embodiment need meet or achieve each and every object, feature, or advantage. Instead, different embodiments may have different objects, features, or advantages.

According to one aspect a manure applicator is provided. The manure applicator may include a tool bar, a plurality of spaced apart application points along the tool bar, a distribution manifold operatively connected to the tool bar and configured to receive a supply of manure under pressure pumped from a manure reservoir, a plurality of discharge lines, each of the plurality of discharge lines between the distribution manifold and one of the plurality of spaced apart application points, a plurality of independent and separate flow meters, with each of the flow meters along one of the plurality of discharge lines, and a plurality of independent and separate flow valves, with each of the flow valves along one of the plurality of discharge lines. Each of the plurality of flow meters may be configured to measure a flow rate associated with the discharge line associated therewith. Each of the plurality of flow valves may be configured to control the flow rate associated with the discharge line the flow valve is associated therewith.

According to another aspect, a method of applying manure with a manure applicator includes providing the manure applicator, the manure applicator including a tool bar, a plurality of spaced apart application points along the tool bar, a distribution manifold operatively connected to the tool bar and configured to receive a supply of manure under pressure pumped from a manure reservoir, a plurality of discharge lines, each of the plurality of discharge lines between the distribution manifold and one of the plurality of spaced apart application points, a plurality of independent and separate flow meters, with each of the flow meters along one of the plurality of discharge lines, and a plurality of independent and separate flow valves, with each of the flow valves along one of the plurality of discharge lines. The method further includes steps of measuring a flow rate at the discharge lines with each of the plurality of flow meters and controlling the flow rate at each of the discharge lines with the plurality of flow valves.

### BRIEF DESCRIPTION OF THE FIGURES

FIG. 1 is a diagram illustrating one embodiment of a manure applicator system.

FIG. 2 is a further diagram of a manure applicator system.

FIG. 3 is another diagram of a manure applicator system where the manure reservoir is in the form of a tank.

FIG. 4 is another diagram of a manure applicator system where the manure reservoir is in the form of manure storage such as a lagoon, slurry store or pit or other manure storage where a drag hose implementation may be appropriate.

FIG. 5 is a diagram of one example of a method of using a manure applicator.

### DETAILED DESCRIPTION

A manure applicator provides for ensuring even distribution of manure by having a separate and independent flow meter and flow valve for each discharge line. This is advantageous as it allows for desired flow rates to be maintained across the entire width of a swath of the manure applicator. This may be of particular importance on slopes or other uneven terrain. In addition, data regarding the flow rates for each discharge line may be recorded to provide evidence of compliance with manure management plans. Because there are independent flow meters and flow valves, different pressures may also be used for different lines.

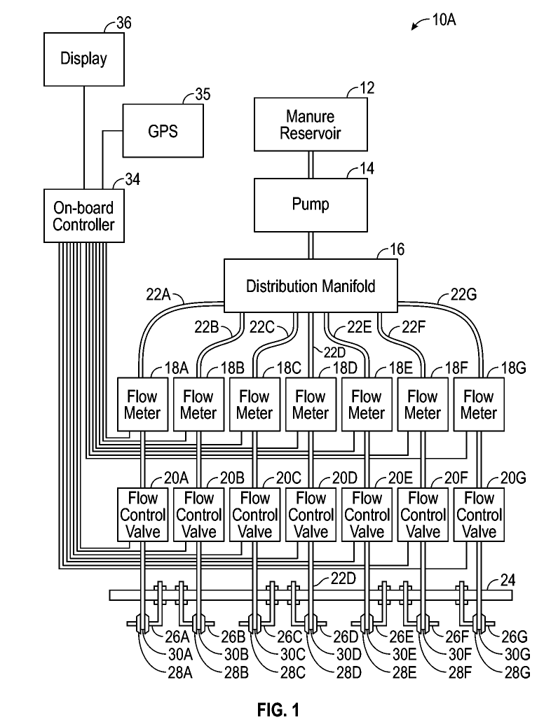

FIG. 1 is a diagram illustrating one embodiment of a manure applicator system. As shown in FIG. 1 there is a manure applicator system 10A. Within the manure applicator system 10A there is a manure reservoir 12. The manure reservoir 12 may be in the form of an implemented mounted manure tank or may be in the form of other manure storage such as may be associated with drag hose type systems. Thus, the manure reservoir may be a lagoon, slurry store, pit, or other form of manure storage. A pump 14 is fluidly connected to the manure reservoir 12 to pump manure under high pressure to the manure distribution manifold 16. The pump 14 may be of various types. For example, the pump 14 may be a hydraulic pump 14. The manure distribution manifold 16 provides for conveying manure to each of a plurality of different discharge lines 22A, 22B, 22C, 22D, 22E, 22F, 22G. Although seven (7) lines are shown it is to be understood that more or fewer lines may be present.

Along each of the discharge lines 22A, 22B, 22C, 22D, 22E, 22F, 22G is a flow meter 18A, 18B, 18C, 18D, 18E, 18F, 18G followed by a flow control valve 20A, 20B, 20C, 20D, 20E, 20F, 20G. Each flow control valve 20A, 20B, 20C, 20D, 20E, 20F, 20G may be used to independently control fluid flow along its associated discharge line 22A, 22B, 22C, 22D, 22E, 22F, 22G to its associated discharge point 30A, 30B, 30C, 30D, 30E, 30F, 30G. The discharge points or application points 30A-30G may be spaced apart and positioned along a length of a toolbar 24. Support arms 26A, 20B, 26C, 26D, 26E, 26F, 26G may support coulter blades or other hardware so that the manure is injected into the ground to reduce odor.

Each of the flow meters 18A, 18B, 18C, 18D, 18E, 18F, 18G and each of the flow control valves 20A, 20B, 20C, 20D, 20E, 20F, 20G is operatively connected to an on-board controller 34. Separate electrical lines are shown to emphasize that each of the flow meters independently and separately senses flow in its respective discharge line and each of the flow control valves may be independently and separate controlled. It is to be understood, however, that instead of separate electrical lines a bus may be used with control implemented via any number of acceptable protocols including without limitation SPI or I2C protocols. The on-board controller 34 may be operatively connected to a display 36 which may, for example, be placed within the cab of a tractor. The display 36 may be a touch screen display or may otherwise provide for receiving user input. A GPS receiver 35 may also be operatively connected to the on-board controller 34 and/or the display 36 to provide location information and/or speed information. If an application rate is set in gallons per acre, the necessary flow rates may vary based on the speed of the vehicle applying the manure so that the higher the speed, the higher the flow rate needed to obtain a particular gallons per acre application rate (e.g. 1000 gallons per acre to 6000 gallons per acre) as an acre would be covered in less time. The location information may be used to create data for an as-applied map for the manure. The use of such a map may be helpful in showing compliance with environmental regulations. The location information may also be used to control flow rates according to a prescription map for a field if it is determined that uniform application is not desired but instead different areas of the field should receive differing amounts of manure. In addition, the mapping may be used to define restricted zones where manure is not applied to comply with one's plan or applicable regulations.

In one use, coverage of manure is provided at a constant application rate (such as may be measured in gallons per acre or in volume per land area or equivalently) and by maintaining a consistent flow rate (which may be tied to a given speed) for each of the discharge lines. Each of the discharge lines may have a different flow rate as measured by its respective flow meter, however the respective flow control valve may be controlled to modify the flow rate so as to make the flow rate at the discharge be substantially identical for the application point for each of the discharge lines. The flow control valve may alter the flow rate by varying the size of its flow passage. The ability to separately and independent control flow rate for each discharge line may be highly advantageous in various situations such as when manure is being applied along a slope or in other situations not conducive to uniform flow rate using traditional methods. It is to be understood that in this application the discharge lines may be relatively large such as three inches, four inches, or greater.

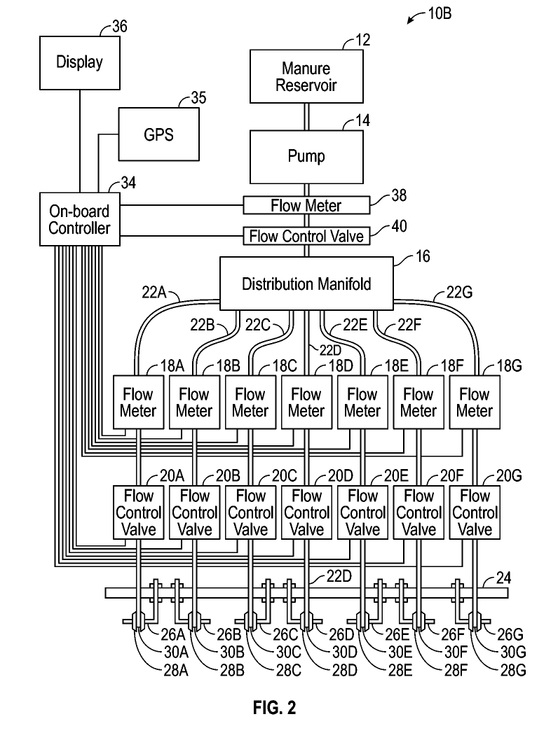

FIG. 2 is a further diagram of a manure applicator system 10B. The manure applicator system 10B is similar to that shown in FIG. 1, however in addition to the separate and independent flow meters and flow control valves for each discharge line, there is also a flow meter 38 and flow control valve 40 between the pump 14 and the manure distribution manifold 16. This embodiment recognizes that the on-board controller 34 may be used to control flow meters and flow control valves at each of the discharge lines as well as flow going into the distribution manifold.

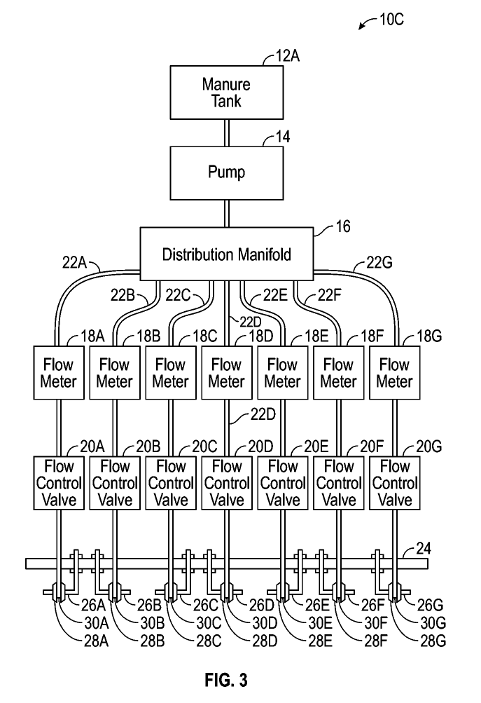

FIG. 3 is another diagram of a manure applicator system 10C where the manure reservoir is in the form of a tank 12A.

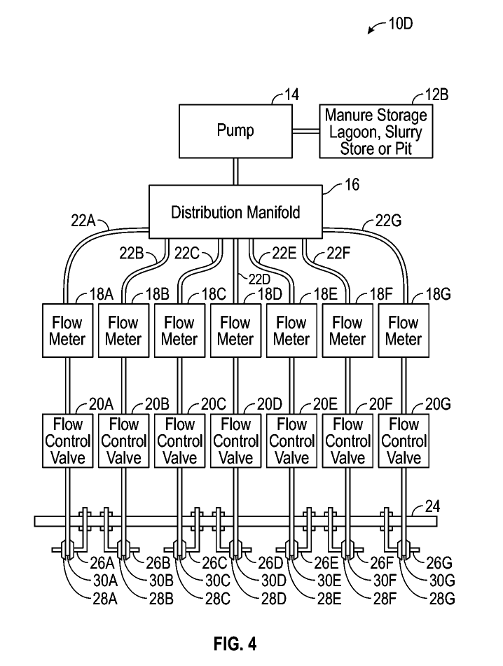

FIG. 4 is another diagram of a manure applicator system 10D where the manure reservoir is in the form of manure storage such as a lagoon, slurry store or pit or other manure storage where a drag hose implementation may be appropriate.

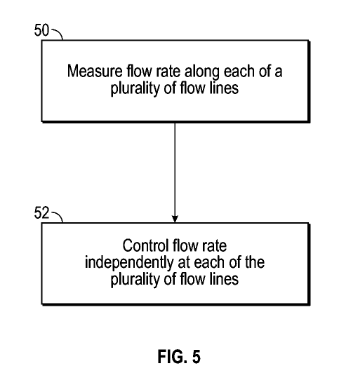

FIG. 5 is a diagram of one example of a method of using a manure applicator. In step 50 the flow rate is measured at each of a plurality of flow lines. In step 52 the flow rate is independently controlled at each of the plurality of flow lines.

Therefore, systems and methods for a manure applicator have been shown and described. Although specific embodiments are provided here, it is contemplated that there may be various options and alternatives as may be appropriate in a particular application or environment. For example, variations in the type of manure reservoir, the number of row units, the flow rates, and other variations are contemplated.

1. A manure applicator comprising:
a tool bar;
a plurality of spaced apart application points along the tool bar;
a pump for pressurizing a supply of manure;
a distribution manifold operatively connected to the tool bar and configured to receive the supply of manure under pressure pumped from a manure reservoir using the pump;
a plurality of discharge lines, each of the plurality of discharge lines between the distribution manifold and one of the plurality of spaced apart application points;
a plurality of independent and separate flow meters, with each of the flow meters along one of the plurality of discharge lines;
a plurality of independent and separate flow valves, with each of the flow valves along one of the plurality of discharge lines;
wherein each of the plurality of flow meters is configured to measure a flow rate associated with the discharge line associated therewith; and
wherein each of the plurality of flow valves is configured to control the flow rate associated with the discharge line the flow valve is associated therewith.

2. The manure applicator of claim 1 further comprising an on-board rate controller operatively connected to each of the plurality of independent and separate flow meters and each of the plurality of independent and separate flow valves.

3. The manure applicator of claim 2 wherein the on-board rate controller is configured to control each of the plurality of the independent and separate flow valves in order to maintain the flow rate of each of the discharge lines at substantially identical pressures.

4. The manure applicator of claim 3 further comprising a display operatively connected to the on-board rate controller.

5. The manure applicator of claim 4 further comprising a global positioning system receiver operatively connected to the display.

6. The manure applicator of claim 1 wherein the manure reservoir comprises a tank containing the manure.

7. The manure applicator of claim 6 wherein the tank is operatively connected to the tool bar.

8. (canceled)

9. The manure applicator of claim 1 wherein the pump is operatively connected to the tool bar.

10. A method of applying manure with a manure applicator, the method comprising:
providing the manure applicator, the manure applicator comprising:
a tool bar,
a plurality of spaced apart application points along the tool bar,
a pump for pressurizing a supply of manure:
a distribution manifold operatively connected to the tool bar and configured to receive the supply of manure under pressure pumped from a manure reservoir using the pump,
a plurality of discharge lines, each of the plurality of discharge lines between the distribution manifold and one of the plurality of spaced apart application points,
a plurality of independent and separate flow meters, with each of the flow meters along one of the plurality of discharge lines, and
a plurality of independent and separate flow valves, with each of the flow valves along one of the plurality of discharge lines;
pumpling the manure through the distribution manifold and the discharge lines using the pump;
measuring a flow rate of the manure at the discharge lines with each of the plurality of flow meters; and
controlling the flow rate of the manure at each of the discharge lines with the plurality of flow valves.

11. The method of claim 10 further comprising receiving the flow rate at the discharge lines at an on-board rate controller operatively connected to the each of the plurality of flow meters.

12. The method of claim 11 wherein the controlling the flow rate is performed using the on-board rate controller, the on-board rate controller operatively connected to each of the plurality of independent and separate flow valves.

13. The method of claim 12 wherein the on-board rate controller provides for maintaining the flow rate of each of the discharge lines at substantially identical pressures.

14. (canceled)
